(19) United States
(12) Patent Application Publication
(10) Pub. No.: US 2024/0346508 A1
(43) Pub. Date: Oct. 17, 2024

(54) CHAINING TRANSACTIONS FOR FRAUD PREVENTION

(71) Applicant: MASTERCARD INTERNATIONAL INCORPORATED, PURCHASE, NY (US)

(72) Inventor: David Alexander Jevans, Menlo Park, CA (US)

(21) Appl. No.: 18/622,848

(22) Filed: Mar. 29, 2024

Related U.S. Application Data
(60) Provisional application No. 63/496,398, filed on Apr. 15, 2023.

(51) Int. Cl. G06Q 20/40; G06Q 20/36

(52) U.S. Cl. CPC G06Q 20/4016; G06Q 20/367; G06Q 2220/00

(57) ABSTRACT

Fraud transactions are detected in peer-to-peer payments without an intermediary. Audit trails associated with a chain of transactions to transfer digital currency from an initial sending wallet to a final receiving wallet are generated and associated with a token of the digital currency. Each token maintains an audit trail of intermediate digital wallets through which that token transacted before being received by the final receiving wallet. A request is received to identify whether a first transaction, of the chain of transactions, is a fraud transaction. In response to the request, a first audit trail associated with a first token associated with the first transaction is retrieved. When wallet cloning or value manipulation is detected, by analyzing the first audit trail, in the first token associated with the first transaction, the first transaction is determined as the fraud transaction.

### CROSS-REFERENCE TO RELATED APPLICATION

This non-provisional utility application claims priority to provisional patent application No. 63/496,398, entitled “Chaining Transactions for Fraud Prevention on Peer-to-Peer Payments”, and filed on Apr. 15, 2023, which is incorporated herein in its entirety by reference.

### BACKGROUND

Users can transmit data from one computing device to another via several options. Many users upload data from one computing device to a server so that other users can download data from the server to another computing device. Alternatively, users can use peer-to-peer data transmission techniques to enable the direct transfer of data from a sender to a recipient.

### SUMMARY

Some examples provide a system for detecting fraud transactions in peer-to-peer payments without an intermediary. The system comprises a processor and a computer storage medium storing instructions that cause the processor to receive a request to identify whether a chain of transactions transferring digital currency of one or more digital currency tokens is a fraud transaction; retrieve a first audit trail associated with a first digital currency token associated with a first transaction, where the first transaction is a part of the chain of transactions and is associated with one of the one or more digital currency tokens; detect wallet cloning or value manipulation in the first digital currency token associated with the first transaction at least by analyzing the first audit trail; and designate the first transaction as the fraud transaction based on detecting the wallet cloning or value manipulation. Each sending wallet is configured to generate one or more audit trails associated with the transaction to transfer digital currency from a sending wallet to a receiving wallet; digitally append one or more elements of a digital credential of the receiving wallet to each of the one or more digital currency tokens; and cryptographically sign each of the one or more digital currency tokens prior to transferring to the receiving wallet, wherein each digital currency token maintains an audit trail of digital wallets through which that digital currency token transacts before being received by the receiving wallet.

Other examples provide a method for generating one or more audit trails associated with a transaction to transfer digital currency from a sending wallet to a receiving wallet, an amount of the digital currency being divided into one or more digital currency tokens, the sending wallet digitally appending one or more elements of a digital credential of the receiving wallet to each of the one or more digital currency tokens and cryptographically signing each of the one or more digital currency tokens prior to transferring to the receiving wallet, each digital currency token maintaining an audit trail of digital wallets through which that digital currency token transacts before being received by the receiving wallet; receiving a request to identify whether a first transaction is a fraud transaction, the first transaction being a part of the transaction and is associated with one of the one or more digital currency tokens; and in response to receiving the request: retrieving a first audit trail associated with a first digital currency token associated with the first transaction; detecting wallet cloning or value manipulation in the first digital currency token associated with the first transaction at least by analyzing the first audit trail; and based on detecting the wallet cloning or value manipulation, designating the first transaction as the fraud transaction.

Still other examples provide a computer storage medium storing computer-executable instructions that, upon execution by a processor, cause the processor to at least: generate one or more audit trails associated with a chain of transactions to transfer digital currency from a sending wallet to a receiving wallet, an amount of the digital currency comprising one or more digital currency tokens, a sending wallet digitally appending one or more elements of a digital credential of the receiving wallet to each of the one or more digital currency tokens and cryptographically signing each of the one or more digital currency tokens prior to transferring to the receiving wallet, each digital currency token maintaining an audit trail of digital wallets through which that digital currency token transacted before being received by the receiving wallet; receive a request to identify whether a first transaction is a fraud transaction, the first transaction being a part of the transaction and is associated with one of the one or more digital currency tokens; and in response to receiving the request: retrieve a first audit trail associated with a first digital currency token associated with the first transaction; detect wallet cloning or value manipulation in the first digital currency token associated with the first transaction by analyzing the first audit trail; and based on detecting the wallet cloning or value manipulation, designate the first transaction as the fraud transaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present description will be better understood from the following detailed description read considering the accompanying drawings, wherein:

FIG. 1 is a block diagram illustrating an example system configured for detecting fraud transactions in peer-to-peer payments;

FIG. 2 is a block diagram illustrating an example system configured for generating audit trails;

FIG. 3 is a flowchart illustrating an example method for transferring digital currency tokens to a receiving wallet;

FIG. 4 is a flowchart illustrating an example method for detecting fraud transactions in peer-to-peer payments;

FIG. 5A is a block diagram illustrating an example token;

FIG. 5B is a block diagram illustrating an example audit trail;

FIG. 5C is a block diagram illustrating an example token including multiple audit trails; and

FIG. 6 illustrates an example computing apparatus as a functional block diagram.

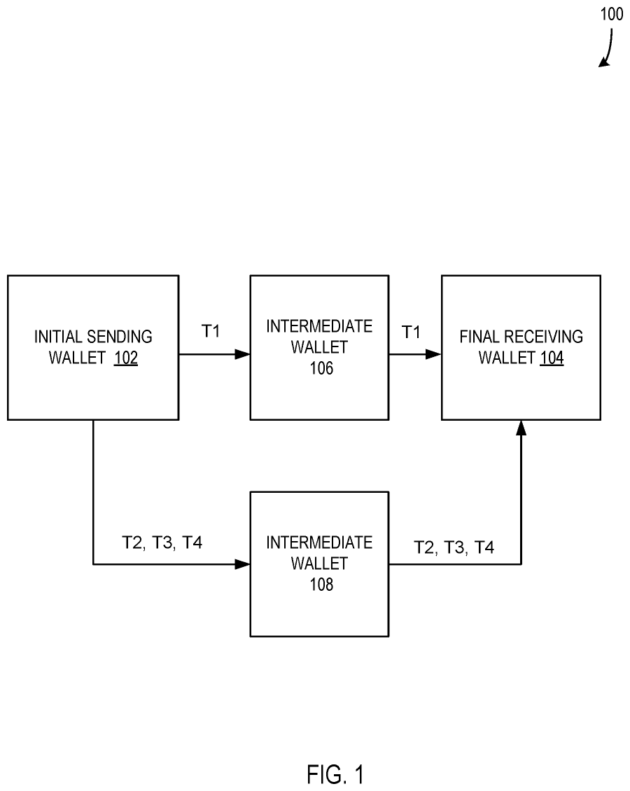

Corresponding reference characters indicate corresponding parts throughout the drawings. In FIGS. 1 to 6, the systems are illustrated as schematic drawings. The drawings may not be to scale. Any of the figures may be combined into a single example or embodiment.

### DETAILED DESCRIPTION

Card-to-card payments, performed in the physical world without the need for a merchant terminal, phone, or internet connection, can open up cash economies in developing countries to digital payments and eventually possible entry into the financial system to gain access to credit, micro investment, and other services. A large percentage of people in various countries still use cash, which is inconvenient for both locals and visitors. This cash cannot be spent online, which limits investment, import/export, and tourist spending in these countries.

Peer-to-peer transactions are difficult to track particularly when a transaction amount associated with a transaction is broken down into multiple transaction amounts and multiple transactions associated with the multiple transaction amounts take place. For example, a fraudster can take advantage by manipulating the transaction value of one or more of the multiple transactions or by cloning a fake wallet as a receiving wallet. A simple ledger is not sufficient in case of such an attack, and as such, peer-to-peer payments are not safe.

In contrast, aspects of the disclosure provide systems and methods for detecting fraud transactions in peer-to-peer payments without an intermediary. The disclosure is configured to generate audit trails associated with a chain of transactions to transfer digital currency from an initial sending wallet to a final receiving wallet. An amount of the digital currency is broken into one or more digital currency tokens. For example, when the transaction is made to transfer digital currency from one wallet to another, the amounts are comprised of fixed denomination digital currency tokens. In an example, a digital wallet is able to load digital currency tokens of $1, $5, $10, $20 or any combination up to a potentially defined limit for that wallet. For clarity, if a digital currency of value $35 is to be transferred from the sending wallet to the receiving wallet, the $35 can be broken into five $1 tokens, a $20 token, and two $5 tokens.

When a transaction is made between two digital wallets, the sending wallet digitally appends elements of the digital credential of the receiving wallet to each digital currency token and also cryptographically signs each digital currency token prior to transferring to the receiving wallet. When the receiving digital wallet uses a received token, it performs the same process. That is, the receiving wallet becomes the sending wallet to send the token to another wallet which now becomes the receiving wallet. This process repeats until the token arrives at the final receiving wallet. Through this mechanism, the token maintains an audit trail, which in some examples is a list of digital wallets that the token passed through for the transaction. Thus, each digital currency token maintains an audit trail of digital wallets through which that digital currency token transacted (e.g., was transferred) before being received by the final receiving wallet.

This audit trail is retrievable by acquirers or their network operators for fraud detection purposes. Such an audit trail can be used to detect and investigate wallet cloning or value manipulation (e.g., by manipulating token values, cloning tokens, creating counterfeit tokens). For example, a request is received (e.g., from an acquirer or a legally authorized law enforcement agency if they possess the digital wallet) to identify whether a first transaction (e.g., a $1, a $20, or a $5 transaction), which is a part of the transaction and associated with one of the digital currency tokens, is a fraud transaction. In response to the request, a first audit trail associated with a first digital currency token associated with the first transaction is retrieved. The first audit trail is analyzed and if wallet cloning or value manipulation is detected in the first digital currency token associated with the first transaction, the first transaction is determined to be the fraud transaction. For example, the first transaction is flagged, marked, or otherwise designated as fraudulent.

Analyzing the first audit trail comprises one or more of: analyzing token value manipulation in the first digital currency token (e.g., token value of $1 token may be manipulated by a fraudster to $5 which is a greater token value than $1), analyzing whether the first digital currency token is a clone of a second digital currency token (e.g., a clone of the $20 token may be created by a fraudster), and/or analyzing whether the first digital currency token is a counterfeit token (e.g., a counterfeit token of $10 token value may be created by a fraudster).

The disclosure operates in an unconventional manner at least by maintaining an audit trail of digital wallets through which a particular digital currency token transacted before being received by the final receiving wallet. The audit trail traces transaction chains, without an intermediary (e.g., without a third-party intermediary for signing and/or validating the digital currency token), if needed for fraud prevention or legal law enforcement investigations. The audit trail is secured through encryption for privacy protection, yet made available for fraud detection or legal law enforcement investigation purposes. Thus, a technical solution is provided to a technical problem.

Further, maintaining the audit trail enables the disclosure to be flexible, which reduces the computational burden on a device for identifying and/or preventing a fraud transaction, thereby improving the function of the device. Enabling safe peer-to-peer payments without an intermediary eliminates the need for an intermediary server. Thus, the use of computing system resources is reduced for tracing transaction chains for fraud prevention or legal law enforcement investigations. It enables post-hoc investigation and detection of fraud, which enables truly peer-to-peer transactions over the Internet or in the physical world with battery powered credit/debit cards or low powered phones.

In sum, a computerized method for detecting fraud transactions in peer-to-peer payments without an intermediary is described. Audit trails associated with a chain of transactions to transfer digital currency from an initial sending wallet to a final receiving wallet are generated. An amount of the digital currency comprises one or more digital currency tokens. The sending wallet, or other logic, digitally appends elements of a digital credential of the receiving wallet and the sending wallet to each digital currency token and also cryptographically signs each digital currency token prior to transferring to the receiving wallet. Each digital currency token maintains an audit trail of digital wallets through which that digital currency token transacted before being received by the receiving wallet. A request is received to identify whether a first transaction, which is a part of the transaction and associated with one of the digital currency tokens, is a fraud or sanctioned transaction. In response to the request, a first audit trail associated with a first digital currency token associated with the first transaction is retrieved. When wallet cloning or value manipulation is detected, such as by analyzing the first audit trail, in the first digital currency token associated with the first transaction, the first transaction is designated to be a fraudulent transaction.

FIG. 1 is a block diagram illustrating an example system 100 configured for detecting fraud transactions in peer-to-peer payments. In some examples, the system 100 includes an initial sending wallet 102 to transfer an amount of digital currency to a final receiving wallet 104. For example, a first token T1 (e.g., a $1 token) is sent from the first initial sending wallet 102 to the final receiving wallet 104 via an intermediate wallet 106 thereby generating an audit trail for the token T1. In this case, the intermediate wallet 106 first becomes a receiving wallet for the first initial sending wallet 102 and thereafter becomes a sending wallet for sending the token T1 to the final receiving wallet 104. In this way, the audit trail grows as the token T1 passes through a number of intermediate wallets because each intermediate wallet appends its own audit trail (i.e., elements of digital credentials of the sending wallet and/or the receiving wallet and encrypting the resulting audit trail including the token T1) to the token T1. Depending on the implementation, there may be a lesser or greater number of intermediate wallets (such as intermediate wallet 106) for transferring the token T1 from the initial sending wallet 102 to the final receiving wallet 104.

Similarly, tokens T2, T3, and T4 (e.g., a $20 token, a $5 token, and another $5 token respectively) are sent from the initial sending wallet 102 to the final receiving wallet 104 via an intermediate wallet 108 thereby generating audit trails for the tokens T2, T3, and T4. In this case, the intermediate wallet 108 first becomes a receiving wallet for the initial sending wallet 102 and thereafter becomes a sending wallet for sending the tokens T2, T3, and T4 to the final receiving wallet 104. Depending on the implementation, there may be a lesser or greater number of intermediate wallets (such as intermediate wallet 108) for transferring the tokens T2, T3, and T4 from the initial sending wallet 102 to the final receiving wallet 104. Further, the tokens (such as tokens T1 to T4), in at least one example, are transferred from the initial sending wallet 102 to the final receiving wallet 104 via a different wallet (or a different numbers of intermediate wallets) than that illustrated in FIG. 1.

Each digital currency token maintains an audit trail of digital wallets through which that digital currency token has transacted before being received by the final receiving wallet 104. For example, as illustrated in FIG. 1, initial sending wallet 102 appends elements of digital credentials of the intermediate wallet 106 to the token T1 and cryptographically signs the token T1 before transferring to the wallet 106. Now, the wallet 106 acts as a sending wallet and appends elements of digital credentials of the final receiving wallet 104 to the token T1 and cryptographically signs the token T1 before transferring to the final receiving wallet 104. A person skilled in the art will appreciate that the tokens T1 shown in FIG. 1 are different because they are appended with elements of digital credentials of the respective receiving wallet (e.g., wallet 106 initially and 104 later on) and also cryptographically signed by the respective sending wallet (e.g., wallet 102 initially and wallet 106 later on).

In some embodiments, the audit trails are encrypted and attached to its respective digital currency token. Thus, the audit trails are stored in encrypted form by the digital wallet. The audit trails are encrypted using an encryption key issued by one or more issuer servers. In some examples, the audit trails are encrypted multiple times by a multitude of encryption keys. Using a multitude of encryption keys would require all of the holders of the audit trail decryption keys to agree to decrypt the audit trail. The failure of any one of the holders of the audit trail decryption keys would prevent the audit trail from being decrypted and read.

In some examples, the one or more audit trails (i.e., the token audit trail data) are stored multiple times with the one or more digital currency tokens, with each copy of the one or more audit trails being encrypted with one or more audit trail encryption keys. This allows the audit trail to be decrypted and viewed by a plurality of holders of the corresponding decryption keys to the audit trail data copy. In some examples, multi-party key management schemes can be applied to this model of the one or more digital currency tokens, that includes encrypting a decryption key with the encryption keys of a multitude of audit trail decryption key holders. For example, the audit trails of each logged transaction are encrypted so that the audit trails can only be accessed by authorized parties like payment processors, law enforcement, or a combination of both.

In some implementations, the initial sending wallet 102 is issued by an issuer server and takes the form of software on a computer, an app on a mobile phone, a credit or debit card, or a service on the Internet or other network. Depending on the implementation, the final receiving wallet 104 is associated with an acquirer (e.g., a merchant) that accepts the digital cash from one or more digital wallets such as the initial sending wallet 102. The issuer server issues or receives a digital credential (e.g., an account number, and/or a public or private encryption key) to or from a digital wallet. The issuer server receives a credential if they are generated by the digital wallet, or issues one to the digital wallets that do not generate their own keys.

In some examples, the digital credential is a digital certificate which is signed by the private key of the issuer and countersigned by the digital wallet. The signed certificate or credential includes the elements of the digital credential (e.g., an account number, an issuer ID, an expiration date, transaction limits, and customization features such as wallet total limits, branding, foreign exchange). A digital wallet is loaded with digital currency. Depending on the implementation, the digital wallet is loaded by one or more of a bank, a wallet issuer, a payment gateway, a Virtual Asset Service Provider (VASP), an ATM cash machine, an acquirer, a merchant, and the like. The digital wallet can also be loaded with digital currency from one or more other digital wallets, in a so-called “transaction”-such as the transaction for sending digital currency from the initial sending wallet 102 to the final receiving wallet 104 that will load the wallet 104 with the digital currency.

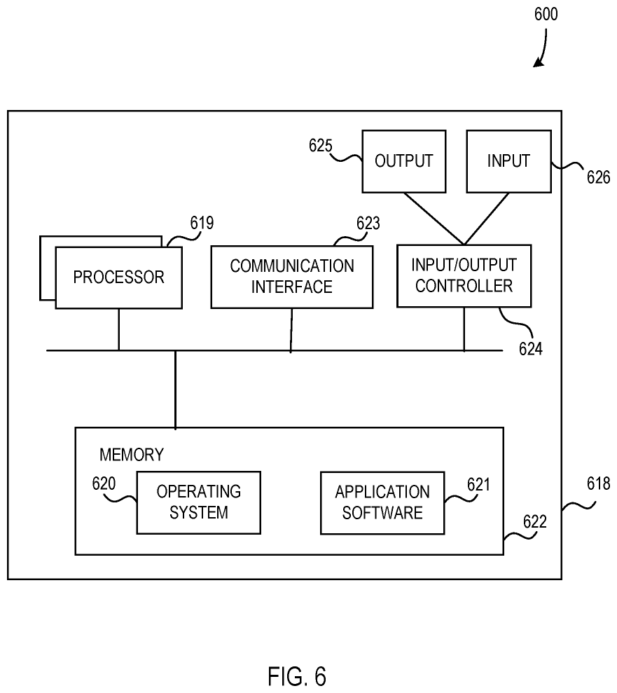

Further, in some examples, the digital wallets (such as the digital wallets 102-108) of system 100 are implemented on one or more computing devices (e.g., the computing apparatus of FIG. 6) that are configured to communicate with each other via one or more communication networks (e.g., an intranet, the Internet, a cellular network, other wireless network, other wired network, or the like).

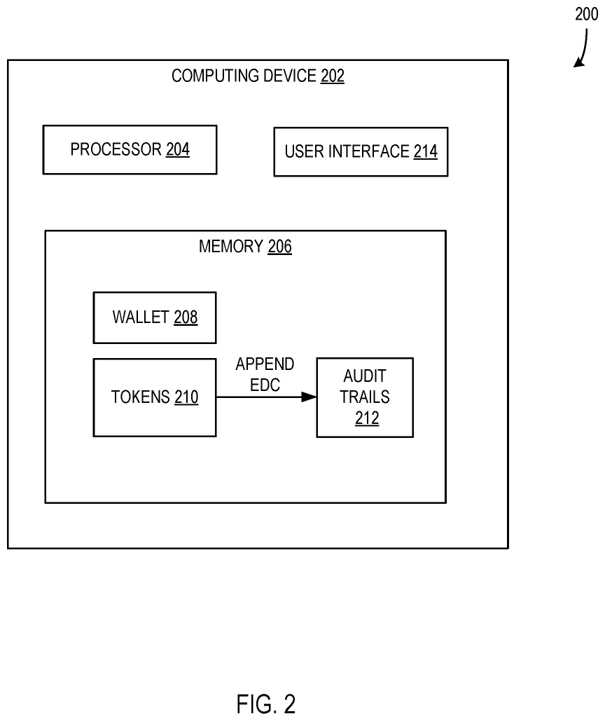

FIG. 2 is a block diagram illustrating an example system 200 configured for generating one or more audit trails 212. In some examples, the system 200 is used to implement a wallet (such as a wallet 102-108) illustrated as system 100 of FIG. 1. Further, it should be understood that the computing device 202 generates the audit trails 212 for detecting fraud transactions in peer-to-peer payments without an intermediary. The computing device 202 includes a processor 204 and a memory 206. In some implementations, the memory 206 stores a digital wallet 208 (such as a wallet 102-108 in FIG. 1) and tokens 210 for transferring an amount of digital currency from the digital wallet 208 (which may act as the initial sending wallet 102) to another wallet such as a final receiving wallet 104. The digital wallet 208 appends elements of an electronic digital credential (EDC) of the receiving wallet to each of the tokens 210 thereby generating the audit trails 212. For clarity, the audit trails 212 is shown separately from tokens 210, however, the audit trails 212 are not stored separately from the tokens 210 which reduces the security risk of someone wiping the audit trails 212 but still redeeming funds. Depending on the implementation, the EDC includes an account number, an issuer ID, an expiration date, transaction limits, or customization features.

In some examples, the audit trails 212 are stored in the memory 206 as a blockchain. For example, audit trails 212 for T1-T4 (as shown in FIG. 1) are stored in different blockchains. These blockchains can be analyzed through machine learning for evidence of fraudulent behavior. The analyses include scoring and other actionable metrics that allow entities to fulfill their compliance requirements such as anti-money laundering compliance. Entities that can implement the present disclosure include but are not limited to issuer servers, acquirer servers, cryptocurrency exchanges/platforms, hedge funds, money service businesses, regulators (e.g., government agencies), intelligence agencies, attorneys, auditors, banks, brokerages, and security researchers.

Storing the audit trails 212 in a blockchain is technically advantageous because it enables the audit trails 212 to be analyzed to determine whether the transaction or a part thereof has been modified due to fraudulent behavior of a fraudster, as described herein.

In some implementations, the computing device 202 has a user interface (UI) 214 that prompts a user of the computing device 202 to enter the amount of the digital currency to transfer from the initial sending wallet 102 to the final receiving wallet 104. In some examples, if part of the transaction is determined to be a fraudulent transaction, the UI 214 displays to the user that the transaction has been modified by a fraudster before transfer to the final receiving wallet 104 and therefore the transaction has been declined. In this way, fraud transactions may be prevented in real time by aspects of the disclosure.

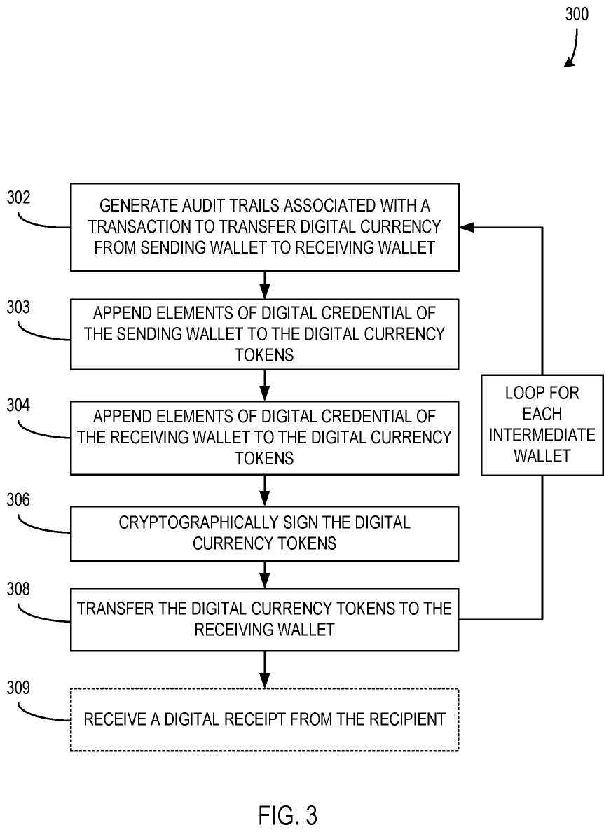

FIG. 3 is a flowchart illustrating an example method 300 for transferring digital currency tokens from a sending wallet to a receiving wallet. The method 300 details steps of generating audit trails for the digital currency tokens for each sending wallet. The method 300 loops for each intermediate wallet the digital currency tokens transact through until arriving at a final receiving wallet. In some examples, the method is executed or otherwise performed by a system such as system 100 of FIG. 1 or system 200 of FIG. 2.

At operation 302, audit trails associated with a transaction to transfer digital currency from a sending wallet to a receiving wallet are generated. An amount of the digital currency comprises one or more digital currency tokens. At operation 303, one or more elements of a digital credential of the sending wallet are appended to each of the one or more digital currency tokens. At operation 304, one or more elements of a digital credential of the receiving wallet are appended to each of the one or more digital currency tokens. At operation 306, each of the one or more digital currency tokens is cryptographically signed prior to transferring to the receiving wallet. At operation 308, the sending wallet transfers the one or more digital currency tokens to the receiving wallet. The process loops to operation 302 for each intermediate wallet used to transfer the digital currency tokens from an initial sending wallet to a final receiving wallet. Each intermediate receiving wallet then becomes a sending wallet.

The audit trail is part of the digital currency token and is transferred with the digital currency token. The audit trail is not stored separately from the digital currency token which reduces the security risk of someone wiping the audit trail but still redeeming funds or pestering the customer support of the issuer. In at least one example, the audit trail is capable of being stored separately, but the token has a hash and signature of the audit trail to verify its authenticity. In at least implementation, a one-time-token (OTP) is stored in one or more of the audit trails to verify authenticity and defeat replay attacks.

At optional operation 309, a digital receipt is received from the recipient.

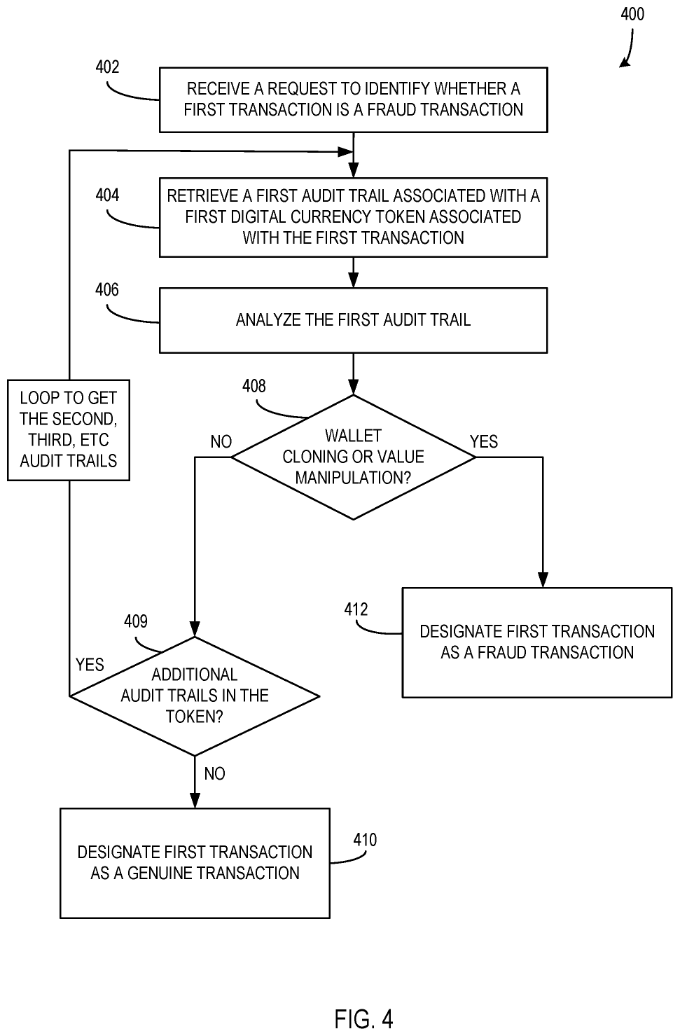

FIG. 4 is a flowchart illustrating an example method 400 for detecting fraud transactions in peer-to-peer payments. In some examples, the method 400 is executed or otherwise performed by a system such as system 200 of FIG. 2.

At operation 402, a request is received to identify whether a first transaction is a fraud transaction. In some examples, the first transaction is a part of the chain of transactions initiated by the initial sending wallet 102 to the final receiving wallet 104. The first transaction is associated with one of the one or more digital currency tokens. In response to the request, a first audit trail associated with a first digital currency token associated with the first transaction is retrieved at operation 404. At operation 406, the first audit trail is analyzed. Based on the analysis it is determined or detected whether wallet cloning or value manipulation has been done in the first digital currency token associated with the first transaction, at operation 408. If wallet cloning or value manipulation is detected at operation 408, the first transaction is determined as a fraud transaction at operation 412. If no wallet cloning or value manipulation is detected at operation 408, then if additional audit trails are determined to be in the first digital currency token at operation 409, the process loops to operation 404 to analyze the next audit trail. For example, if there are five audit trails, then operations 404 through 408 are performed five times. It is only with a full audit trail that the hotspots of fraud can be determined. Depending on the implementation, the contents of the fraud audit trail are a simple as a wallet/card ID and amount with the date and time of the transaction. This audit chain is capable of being linked with other audit chains in the system to detect money mules, wallet replicators, or other fraudulent actors or schemes.

Once there are no further audit trails to analyze at operation 409, and no wallet cloning or value manipulation has been detected, the first transaction is determined to be a genuine transaction at operation 410.

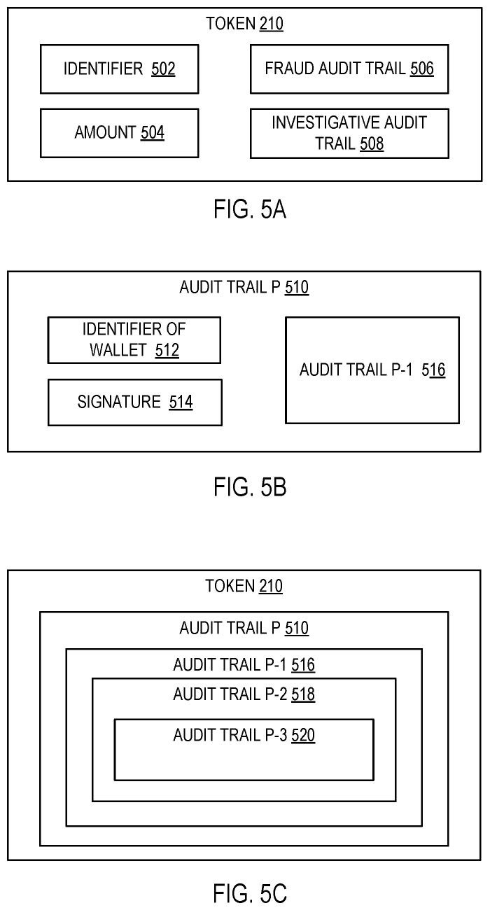

FIG. 5A is a block diagram illustrating an example token such as digital currency token 210. The digital currency token 210 includes an identifier 502 associated with the token that uniquely identifies the digital currency token 210 and an amount 504 represented by the digital currency token 210. There can be more than one audit trails per token. For example, the digital currency token 210 includes both a fraud audit trail 506 and investigative audit trail 508 which are generated as the digital currency token 210 passes through the different wallets (such as the wallets 102-108). The fraud audit trail 506 comprises the trail or a log of transactions such as wallet ID, amount and optionally date or a one-time-token. This audit trail, that can be encrypted with a symmetric or private key, or have a symmetric key encrypted with the public key of the fraud auditor or wallet issuer. This audit trail, combined with analysis of other audit trails that show anomalous behavior either in transaction number or fiat value, can yield valuable and actionable fraud insights without compromising the identity or other personal information of the wallet holder. Whereas one or more investigative audit trails 508 instead contain other data that can be useful in an investigation such as the date and time of a transaction, or potentially the travel rule information required for certain higher value wallets or cards. There can be another audit trail that can carry travel rule information for sanctions and other screening purposes for higher value wallets This reduces the computing resource requirement for detecting a fraudulent transaction because the computing device such as the apparatus 618 needs to process only the fraud audit trail 506 and/or the investigative audit trail 508 instead of processing the whole audit trail P 510 (as illustrated in FIGS. 5B and 5C). It also allows for fraud to be detected that otherwise would not be on a peer-to-peer digital transaction system, and it allows for regulatory compliance with sanctions and other Know Your Customer (KYC) regional requirements by using the key management mechanism to enable the secure and controlled access to data about wallet holders such as true name and other KYC due diligence requirements as required by Financial Action Task Force (FATF) Recommendation 15. This can form the basis for third party reliance on other party's KYC.

FIG. 5B is a block diagram illustrating an example audit trail P 510. The audit trail P 510 includes an identifier of the wallet 512 (e.g., initial sending wallet 102 and/or the final receiving wallet 104) and a signature 514. In some versions, the signature 514 includes a hash of the audit trail P 510 and/or public key or other identifier of the initial sending wallet 102. In an example, the audit trail P 510 includes the audit trail P-1 516 which is the audit trail generated at a previous level. In another example, the audit trail P 510 is generated by the intermediate wallet 106 while the audit trail P-1 516 is generated by the initial sending wallet 102 (as shown in FIG. 1). Depending on the implementation, there may be a greater or lesser number of audit trails than depicted in FIG. 5B without deviating from the aspects of the disclosure.

FIG. 5C is a block diagram illustrating an example token including multiple audit trails. In some implementations, the digital currency token 210 comprises audit trail P 510 which comprises audit trail P-1 516. Similarly, audit trail P-1 516 comprises audit trail P-2 518 which further comprises audit trail P-3 520. In this way, there is a nesting of the audit trails and the path traversed by the token 210 is known from the audit trail P 510 which includes the path traversed by the token from the initiating wallet (e.g., initial sending wallet 102) until the last sending wallet (e.g., intermediate wallet 106). Depending on the implementation, there may be a nesting of a greater or lesser number of audit trails than depicted in FIG. 5C without deviating from the aspects of the disclosure. In at least one example, content of these audit trails are encrypted by one or more key controllers, authorized audit decryptors, and/or auditors.

### Exemplary Operating Environment

The present disclosure is operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hard-coded machine. In some examples, platform software comprising an operating system 620 or any other suitable platform software is provided on the apparatus 618 to enable application software 621 to be executed on the device. In some examples, detecting fraud transactions in peer-to-peer payments without an intermediary as described herein is accomplished by software, hardware, and/or firmware.

In some examples, computer executable instructions are provided using any computer-readable media that is accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium does not include a propagating signal. Propagated signals per se are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 may also output data to devices other than the output device, e.g., a locally connected printing device. In some examples, a user provides input to the input device(s) 626 and/or receives output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a processor; a computer storage medium storing instructions that are operative upon execution by the processor to receive a request to identify whether a chain of transactions to transfer digital currency from an initial sending wallet to a final receiving wallet is a fraud transaction, wherein an amount of the digital currency comprises one or more digital currency tokens; retrieve a first audit trail associated with a first digital currency token associated with a first transaction, wherein the first transaction is a part of the transaction to transfer digital currency from the initial sending wallet to the final receiving wallet and is associated with one of the one or more digital currency tokens; detect wallet cloning or value manipulation in the first digital currency token associated with the first transaction at least by analyzing the first audit trail; and based on detecting the wallet cloning or value manipulation, designate the first transaction as the fraud transaction, wherein each sending wallet is configured to: generate one or more audit trails associated with the transaction to transfer digital currency from a sending wallet to a receiving wallet; digitally append one or more elements of a digital credential of the receiving wallet to each of the one or more digital currency tokens; and cryptographically sign each of the one or more digital currency tokens prior to transferring to the receiving wallet, wherein each digital currency token maintains an audit trail of digital wallets through which that digital currency token transacts before being received by the receiving wallet.

An example computerized method comprises: generating one or more audit trails associated with a transaction to transfer digital currency from a sending wallet to a receiving wallet, an amount of the digital currency being broken into one or more digital currency tokens, the sending wallet digitally appending one or more elements of digital credential of the receiving wallet to each of the one or more digital currency tokens and cryptographically signing the each of the one or more digital currency tokens prior to transferring to the receiving wallet, each digital currency token maintaining an audit trail of digital wallets through which that digital currency token transacted before being received by the receiving wallet; receiving a request to identify whether a first transaction is a fraud transaction, the first transaction being a part of the transaction and is associated with one of the one or more digital currency tokens; and in response to receiving the request: retrieving a first audit trail associated with a first digital currency token associated with the first transaction; detecting wallet cloning or value manipulation in the first digital currency token associated with the first transaction by analyzing the first audit trail; and based on detecting the wallet cloning or value manipulation, determining the first transaction as the fraud transaction.

One or more computer storage media store computer-executable instructions that, upon execution by a processor, cause the processor to at least: generate one or more audit trails associated with a transaction to transfer digital currency from a sending wallet to a receiving wallet, an amount of the digital currency comprising one or more digital currency tokens, the sending wallet digitally appending one or more elements of digital credential of the receiving wallet to each of the one or more digital currency tokens and cryptographically signing the each of the one or more digital currency tokens prior to transferring to the receiving wallet, each digital currency token maintaining an audit trail of digital wallets through which that digital currency token transacted before being received by the receiving wallet; receive a request to identify whether a first transaction is a fraud transaction, the first transaction being a part of the transaction and is associated with one of the one or more digital currency tokens; and in response to receiving the request: retrieve a first audit trail associated with a first digital currency token associated with the first transaction; detect wallet cloning or value manipulation in the first digital currency token associated with the first transaction by analyzing the first audit trail; and based on detecting the wallet cloning or value manipulation, determine the first transaction as the fraud transaction.

Alternatively, or in addition to the other examples described herein, examples include any combination of the following:
wherein analyzing the first audit trail comprises one or more of analyzing token value manipulation in the first digital currency token, analyzing whether the first digital currency token is a clone of a second digital currency token, and analyzing whether the first digital currency token is a counterfeit token.
wherein the one or more audit trails are encrypted and attached to its respective digital currency token.
wherein an encryption key used to encrypt the one or more audit trails is issued by one or more issuer servers.
wherein the one or more audit trails are encrypted multiple times by a multitude of encryption keys.
wherein a decryption key, for decrypting the one or more encrypted audit trails, is encrypted with encryption keys of a multitude of audit trail decryption key holders.
wherein the one or more audit trails are stored multiple times with the one or more digital currency tokens, wherein each copy of the one or more audit trails is encrypted with one or more audit trail encryption keys.
wherein each of the one or more audit trails is stored in the memory as a blockchain.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for detecting fraud transactions in peer-to-peer payments without an intermediary.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for detecting fraud transactions in peer-to-peer payments without an intermediary, the system comprising:
a processor;
a computer storage medium storing instructions that are operative upon execution by the processor to:
receive a request to identify whether a chain of transactions to transfer digital currency from an initial sending wallet to a final receiving wallet is a fraud transaction, wherein an amount of the digital currency comprises one or more digital currency tokens;
retrieve a first audit trail associated with a first digital currency token associated with a first transaction, wherein the first transaction is a part of the chain of transactions and is associated with one of the one or more digital currency tokens;
detect wallet cloning or value manipulation in the first digital currency token associated with the first transaction at least by analyzing the first audit trail; and
based on detecting the wallet cloning or value manipulation, designate the first transaction as the fraud transaction,
wherein each sending wallet starting with the initial sending wallet is configured to:
generate one or more audit trails associated with the transaction to transfer digital currency from the sending wallet to a receiving wallet;
digitally append one or more elements of a digital credential of the receiving wallet to each of the one or more digital currency tokens; and
cryptographically sign each of the one or more digital currency tokens prior to transferring to the receiving wallet, wherein each digital currency token maintains an audit trail of digital wallets through which that digital currency token transacts before being received by the receiving wallet.

2. The system of claim 1, wherein analyzing the first audit trail comprises one or more of the following: analyzing token value manipulation in the first digital currency token, analyzing whether the first digital currency token is a clone of a second digital currency token, and analyzing whether the first digital currency token is a counterfeit token.

3. The system of claim 1, wherein the one or more audit trails are encrypted and attached to its respective digital currency token.

4. The system of claim 3, wherein an encryption key used to encrypt the one or more audit trails is issued by one or more issuer servers.

5. The system of claim 3, wherein the one or more audit trails are encrypted multiple times by a multitude of encryption keys.

6. The system of claim 3, wherein a decryption key, for decrypting the one or more encrypted audit trails, is encrypted with encryption keys of a multitude of audit trail decryption key holders.

7. The system of claim 1, wherein the one or more audit trails are stored multiple times with the one or more digital currency tokens, wherein each copy of the one or more audit trails is encrypted with one or more audit trail encryption keys.

8. The system of claim 1, wherein each of the one or more audit trails is stored in a blockchain.

9. A computerized method comprising:
generating one or more audit trails associated with a chain of transactions to transfer digital currency from a sending wallet to a receiving wallet, an amount of the digital currency being divided into one or more digital currency tokens, the sending wallet digitally appending one or more elements of a digital credential of the receiving wallet to each of the one or more digital currency tokens and cryptographically signing each of the one or more digital currency tokens prior to transferring to the receiving wallet, each digital currency token maintaining an audit trail of digital wallets through which that digital currency token transacts before being received by the receiving wallet;
receiving a request to identify whether a first transaction is a fraud transaction, the first transaction being a part of the transaction and is associated with one of the one or more digital currency tokens; and
in response to receiving the request:
retrieving a first audit trail associated with a first digital currency token associated with the first transaction;
detecting wallet cloning or value manipulation in the first digital currency token associated with the first transaction at least by analyzing the first audit trail; and
based on detecting the wallet cloning or value manipulation, designating the first transaction as the fraud transaction.

10. The computerized method of claim 9, wherein analyzing the first audit trail comprises one or more of the following: analyzing token value manipulation in the first digital currency token, analyzing whether the first digital currency token is a clone of a second digital currency token, and analyzing whether the first digital currency token is a counterfeit token.

11. The computerized method of claim 9, wherein the one or more audit trails are encrypted and attached to its respective digital currency token.

12. The computerized method of claim 11, wherein an encryption key used to encrypt the one or more audit trails is issued by one or more issuer servers.

13. The computerized method of claim 11, wherein the one or more audit trails are encrypted multiple times by a multitude of encryption keys.

14. The computerized method of claim 11, wherein a decryption key, for decrypting the one or more encrypted audit trails, is encrypted with encryption keys of a multitude of audit trail decryption key holders.

15. The computerized method of claim 9, wherein the one or more audit trails are stored multiple times with the one or more digital currency tokens, wherein each copy of the one or more audit trails is encrypted with one or more audit trail encryption keys.

16. The computerized method of claim 9, wherein each of the one or more audit trails is stored in a blockchain.

17. A computer storage medium storing computer-executable instructions that, upon execution by a processor, cause the processor to at least:
generate one or more audit trails associated with a chain of transactions to transfer digital currency from a sending wallet to a receiving wallet, an amount of the digital currency comprising one or more digital currency tokens, a sending wallet digitally appending one or more elements of a digital credential of the receiving wallet to each of the one or more digital currency tokens and cryptographically signing each of the one or more digital currency tokens prior to transferring to the receiving wallet, each digital currency token maintaining an audit trail of digital wallets through which that digital currency token transacted before being received by the receiving wallet;
receive a request to identify whether a first transaction is a fraud transaction, the first transaction being a part of the transaction and is associated with one of the one or more digital currency tokens; and
in response to receiving the request:
retrieve a first audit trail associated with a first digital currency token associated with the first transaction;
detect wallet cloning or value manipulation in the first digital currency token associated with the first transaction by analyzing the first audit trail; and
based on detecting the wallet cloning or value manipulation, designate the first transaction as the fraud transaction.

18. The computer storage medium of claim 17, wherein analyzing the first audit trail comprises one or more of: analyzing token value manipulation in the first digital currency token, analyzing whether the first digital currency token is a clone of a second digital currency token, and analyzing whether the first digital currency token is a counterfeit token.

19. The computer storage medium of claim 17, wherein the one or more audit trails are encrypted and attached to its respective digital currency token.

20. The computer storage medium of claim 17, wherein each of the one or more audit trails is stored in a blockchain.
